(19) United States
(12) Patent Application Publication
(10) Pub. No.: US 2011/0162553 A1
(43) Pub. Date: Jul. 7, 2011

(54) Modularized Motor Or Generator Housing With Cast Attachments Bars

(76) Inventors: Peter Isberg, Vasteras (SE); Per-Olof Lindberg, Vasteras (SE)

(21) Appl. No.: 13/051,794

(22) Filed: Mar. 18, 2011

Related U.S. Application Data
(63) Continuation of application No. PCT/EP2009/060512, filed on Aug. 13, 2009.

(30) Foreign Application Priority Data
Sep. 19, 2008 (EP) 08164662.2

(51) Int. Cl. B61C 3/00; H02K 5/22

(52) U.S. Cl. 105/34.1; 310/91

(57) ABSTRACT

A motor or generator housing for electric traction including a cast housing body with cast or welded fastening areas circumferentially spaced on the envelope surface adapted to be mounting areas for attachment lugs, safety noses, air duct channels or terminal boxes. A bogie attachment device and a safety nose device adapted to be fixed to a motor housing is also contemplated. The devices have attachment areas formed to attach and be fixable to the attachment areas of the motor housing. A motor or generator including such housing is further contemplated.

### CROSS-REFERENCE TO RELATED APPLICATIONS

The present application is a continuation of pending International patent application PCT/EP2009/060512 filed on Aug. 13, 2009 which designates the United States and claims priority from European patent application 08164662.2 filed on Sep. 19, 2008, the content of which is incorporated herein by reference.

### FIELD OF THE INVENTION

The invention relates to electric motor or generator housings (hereafter referred to as simply housings), especially for use in railway traction applications, and more particular to bogie attachment arrangements on the housing.

The invention also relates to a bogie attachment device and a safety nose device adapted to be fixed to a motor housing. It also relates to a motor or generator with such housing.

### BACKGROUND OF THE INVENTION

Drive arrangements for use in railway vehicles comprise a traction motor mounted to the bogie frame which also is supporting the train car body. They further comprise a gearbox coupled to the motor shaft and with or without a cardan shaft coupled to the gearbox and at the other end to the wheels or wheel axle to transfer power for the propelling of the same.

In order to mount the motor on the bogie frame the typical presently known arrangements disclose motor housings with cast or welded attachment lugs.

U.S. Pat. No. 4,170,945 discloses a traction motor with cast attachment lugs for attaching the motor to a rail vehicle bogie frame.

U.S. Pat. No. 5,675,198 discloses a stator frame comprising a connection end casting and a pinion end casting which are welded together. Both castings comprise lugs with lifting holes for mounting and safety notches to prevent the frame from falling in the event of a malfunction.

GB1248957 discloses an electric motor housing formed of die cast metal provided on its outer surface with longitudinally-extending fins. Some of the fins are provided with seating surfaces for for the attachment to the shell of detachable feet or other supports.

DE10318430 discloses an electric machine housing with cooling ribs provided with attachment areas for e.g. feet.

U.S. Pat. No. 6,109,333 and U.S. Pat. No. 5,877,576 disclose an electric motor housing frame comprising a raised area onto which a conduit box may be attached.

Casting of motor housing, for use in railway traction motors, with frames for bogie attachments leads to production and quality problems due to casting defects in the transition areas between the attachment frames and the housing. The housings today are designed for a certain bogie frame and is not possible to fit in other bogies. Therefore the cost is high for traction motors compared to standard low and medium voltage motors. Another problem is that the housing becomes heavy with integrated cast frames for attachment to the bogie while the market request lowest possible weight of the motors.

### SUMMARY OF THE INVENTION

According to one aspect of the present invention the motor housing comprises a cast housing body with cast fastening areas spaced on the envelope surface adapted to be mounting areas for attachment lugs, safety noses, air duct channels or terminal boxes.

According to a further embodiment the shape of the housing is cylindrical, square, pentagonal, hexagonal or higher or an irregular shape.

According to a further embodiment the fastening areas are shaped as axially arranged cast bars.

According to a further embodiment the fastening areas are thicker than the adjacent parts of the housing and protruding outwards.

According to a further embodiment the fastening areas are unevenly or evenly spaced circumferentially.

According to a further embodiment the fastening areas are a fastening area stretches axially along the envelope surface from one end of the housing to another forming a cast bar.

According to a further embodiment the cast bar is divided in two or more shorter bars intermittently arranged stretching axially along the envelope surface from one end of the housing to another.

According to a further embodiment there are three or more cast bars spaced circumferentially.

According to a further embodiment there are five cast bars spaced circumferentially.

According to a further embodiment there are at least two cast boxes arranged on either or each end of the housing surface.

According to a further aspect of the present invention a bogie attachment device has attachment areas formed to attach and be fixable to the attachment areas of the housing.

According to a further embodiment of this aspect of the invention the bogie attachment device has a lug with a through hole which through hole is adapted to receive a mounting bar or rubber bushing fixed on a bogie arrangement on a railway vehicle.

According to a further aspect of the present invention a safety nose device has attachment areas formed to attach and be fixable to the attachment areas of the housing.

### BRIEF DESCRIPTION OF THE DRAWINGS

The features and the advantages of the present invention are further described, by way of example only, in the following description of preferred embodiments, with references to the following drawings of embodiments of the invention, in which:

FIG. 1 shows a traction motor with a motor housing with cast bars on which bars are mounted attachment lugs for attaching the motor to a rail vehicle bogie frame.

FIG. 2 shows a traction motor with a motor housing with cast bars on which bars is mounted a safety nose for securing that the motor will be caught if the attachment to the bogie breaks.

### DETAILED DESCRIPTION OF THE INVENTION

The examples given below are for an open self ventilated motor. However, the invention is also valid for motors and generators using other cooling methods such as closed ventilated, water cooled, forced ventilated etc.

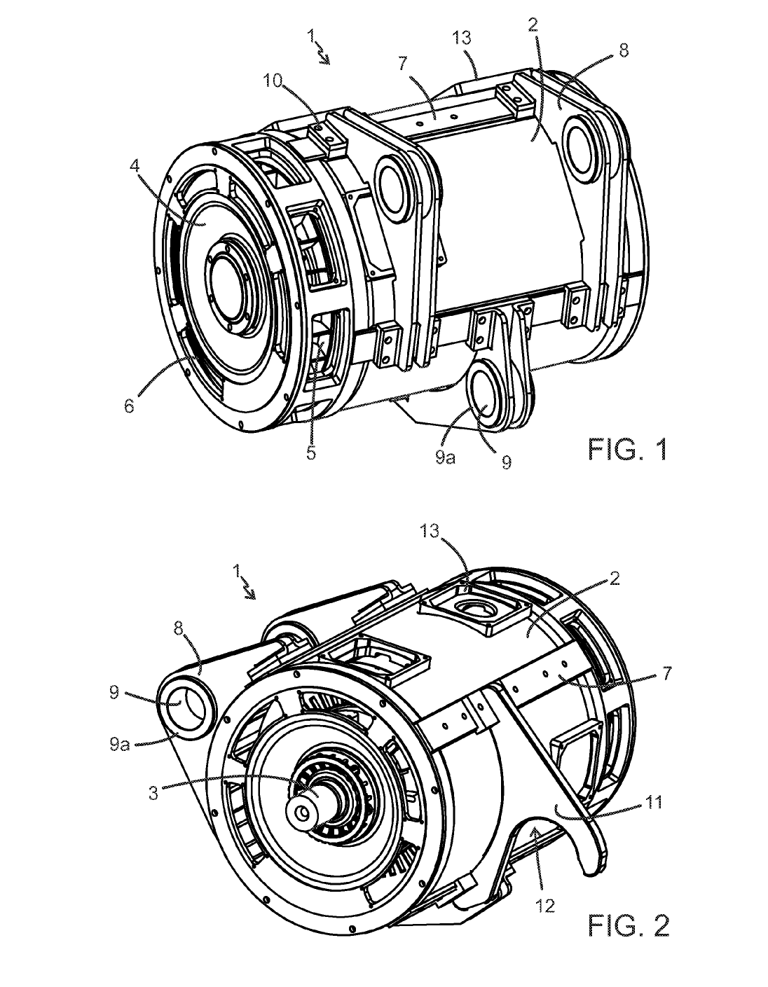

An embodiment of a motor housing 2 is described below referring initially to FIG. 1. A traction motor 1 of self-ventilated type comprises a cylindrical motor housing 2 body which is enveloping a rotor and a stator (not shown). Other configurations of the housing than cylindrical are possible e.g. square, pentagonal, hexagonal or higher shapes. The rotor is arranged concentrically on an out-going rotor shaft 3 to which a coupling connected to a gear box (not shown) may be attached, ultimately driving the driving wheels of the vehicle. The rotor shaft 3 is extending to an end motor shield 4. The end motor shield 4 also comprises ventilating through holes 6. In the embodiment disclosed in the figures, namely a self ventilated motor the through holes 6 are blinded by cover plates. However in a forced ventilated motor these cover plates may be left out or used to cover some of these through holes. The motor housing 2 is preferably cast but can also be welded with fastening areas thicker than the rest of the housing. The fastening areas which are formed as cast bars 7 and stretch longitudinally along the envelope surface from one end of the cylindrical motor housing 2 to the other.

The cast bars 7 are unevenly or evenly spaced around the circumference of the cylindrical motor housing 2 to provide attachment areas for bogie attachment lugs 8 of which three are disclosed in FIG. 1. An uneven arrangement actively damps vibration and avoids resonance peaks in the structure. The cast bars are areas of the housing wall with a larger thickness and thus protruding outwards providing a platform in which suitable holes may be made for fastening the above-mentioned attachment lugs 8. In this meaning axial should be interpreted broadly as a non-cylindrical housing may have outer surfaces whose that are not parallel to the In the embodiment disclosed in the drawings there are 4 cast bars round the circumference but it would be possible to use more or less. An embodiment with 5 evenly spaced cast bars would mean that the overall height of the motor can be minimized leading to e.g. an as low as possible position of the car floor in relation to the wheels or the rails. A traction motor is preferably attached to the bogie in 2 to 4 different attachment positions. The location of the cast bars gives a rotational symmetric attachment to the bogie. Separate attachment lugs 8 are mounted to the cast bars 7 using screws 10. Each lug 8 is attached to two adjacently placed cast bars 7 by two screws 10 or more on each bar 7 in suitably placed screw holes. The lugs 8 are adapted to receive mounting bars or rubber bushings arranged on the railway car bogie frame and are therefore equipped with round through holes 9 in the longitudinal direction of the cylindrical housing 2 mounting the motor 1 in a direction transverse to the vehicle travel direction. The lugs 8 are provided with rubber bushings 9a mounted in the holes 9 damping the transferral of vibrations between the motor 1 and the railway car. This attachment to the cast bars can be designed so minimal shear and drag forces act on the attachment lugs and screws which enable s good shock and fatigue resistance.

As can be seen in FIG. 2 the cast bars 7 may also be used for attaching a safety nose device 11 with a notch 12 in a corresponding way using screws to the housing 2 by which safety nose 11 the motor 1 is intended to be caught in case of breakdown of the motor attachment. The motor 1 through the safety nose 11 with the notch 12 may thus be caught by a catching rod mounted longitudinally under the train car body prohibiting the falling motor or motor parts from its breakdown from damaging the railway car from underneath or flying into the surroundings of the railway track and hitting eventual bystanders. Such safety arrangements will be standard on all electric train cars within the European Union. If the motor 1 should be detached during high speed travelling the motor or parts thereof may flail around and pierce the floor of the car body or cause other damage to the train and may also bounce on the ground and ultimately derail the train.

By using such housing with attachable lugs and safety nose several problems are avoided or lessened. For example the negative effects from the casting process, such as pores due to inhomogeneous cooling in the casting process, may be avoided compared to casting motor houses incorporating bogie attachments and/or safety nose. In the transition sections between the housing and the lugs the casting is often filled with voids and other unwanted phenomena weakening the casting which leads to a high cassation.

The fact that the cast bars 7 are arranged stretching longitudinally along the envelope surface of the cylindrical housing 2 makes it possible to mount the attachment lugs 8 in numerous different ways to adapt to different installation conditions. Also the position of the safety nose 11 may thus be selected to suit different installation conditions using the standardized motor housing of the present invention.

Incorporated in the housing 2 there are also at least two cast boxes 13, one to three on either or each end of the cylindrical housing surface. These cast boxes 13 may be used for mounting an air duct channel when the housing is used for a forced ventilation motor or if a directed air intake is preferred in a self-ventilated motor. The cast boxes 13 may also be used for mounting terminal boxes in a suitable position on the housing. Only the used boxes 13 need then to be machined to contain through holes to the inside of the housing 2 for either the air or the necessary wires and cables for the operation of the motor. The boxes not used remain blanks. This provides an even better flexibility making it possible to adapt the housing to several different assembly possibilities of traction motors. This also implies that the range of tools and equipment for handling the different types of mounting points for different types of motors is no longer required. A cast box with a machined through hole may be covered by a covering plate. The air intake duct and the terminal box may be attached to the cast bars as well using screws and could then be used as falling noses due to their secure attachment to the cast bars.

By using a standard diameter for the housing and varying the length of the motor for obtaining different motor power outputs the cast bars may be used to good effect by lengthen them correspondingly. The same standardized attachment lugs and also safety nose may thus be used for all motor alternatives with a certain housing diameter. The end motor shields are then also standardized and may be used on all motor alternatives. Due to the flexible attachment possibilities and adaptation of different attachment lugs or corresponding attachment devices the same motor housing is possible to use for virtually all traction motor types and installations.

The cast bars disclosed in the embodiment above are axially cast from one end to another of the housing. Other useful embodiments may comprise a divided cast bar including 2 or more shorter bars intermittently cast between the two ends. It has to be said that the attachment to the cast bars not necessarily has to be using screws, but other analogue means like bolts, welding or steering pins or a combination thereof may be used instead.

While the bogie attachment devices in this embodiment are attachment lugs, other railway vehicle manufacturers may use other different types of bogie attachments. Such arrangements are naturally also possible to adapt to the motor housing with its attachment bars, by manufacturing attachments suitable to bogies from different manufacturers adapted to be fastened to the cast bars of the housing.

To the person skilled in the art further modifications and variations of the described embodiments are possible.

1. A housing comprising:
a cast housing body with a plurality of cast or welded fastening areas spaced on the envelope surface of the cast housing body, the fastening areas being adapted to be mounting areas for attachment lugs, safety noses, air duct channels or terminal boxes,
wherein the fastening areas stretch axially along the envelope surface of the cast housing body substantially all the way from one end of the cast housing body to the other end of the cast housing body, and
wherein the width of the fastening areas is greater that the height of the fastening areas, the width being measured in a tangential direction of the cast housing body and the height of the fastening areas being measured in a radial direction of the cast housing body.

2. The housing of claim 1, wherein the shape of the cast housing body is cylindrical, square, pentagonal, hexagonal or higher.

3. The housing of claim 1, wherein the fastening areas are thicker than the adjacent parts of the cast housing body and wherein the fastening areas are protruding outwards.

4. The housing of claim 1, wherein the fastening areas are unevenly spaced circumferentially.

5. The housing of claim 1, wherein the fastening areas are evenly spaced circumferentially.

6. The housing of claim 1, further comprising three or more cast bars spaced circumferentially.

7. The housing of claim 1, further comprising five cast bars spaced circumferentially.

8. The housing of claim 1, further comprising at least two cast boxes arranged on either or each end of the cylindrical housing surface.

9. An attachment device adapted to be fixed to the housing of claim 1, said attachment device having attachment areas formed to attach and be fixable to the attachment areas of the housing.

10. The attachment device of claim 9, wherein the attachment device has a lug with a through hole, the through hole being adapted to receive a mounting bar or rubber bushing fixed on a bogie arrangement on a railway vehicle.

11. A safety nose device adapted to be fixed to the housing of claim 1, the safety nose device having attachment areas formed to attach and be fixable to the attachment areas of the housing.

12. A motor or a generator comprising the housing of claim 1.
